(19) United States
(12) Patent Application Publication
(10) Pub. No.: US 2008/0058147 A1
(43) Pub. Date: Mar. 6, 2008

(54) Control Device For A Hydraulic Differential

(76) Inventor: Stilian Ganchev, Varna (BG)

Correspondence Address: THE WEBB LAW FIRM, P.C., 700 KOPPERS BUILDING, 436 SEVENTH AVENUE, PITTSBURGH, PA, 15219, US

(21) Appl. No.: 10/549,464

(22) PCT Filed: Mar. 17, 2004
(86) PCT No.: PCT/BG04/00006

§ 371 Date: Sep. 14, 2005

(30) Foreign Application Priority Data
Mar. 17, 2003 (BG) 107637

(51) Int. Cl. F16H 48/26

(52) U.S. Cl. 475/84

(57) ABSTRACT

The present invention relates to a control device for hydraulic differentials in vehicles. The object of the invention is to provide a control device for a hydraulic differential, which eliminates the necessity of wheel base devices for distributing of the driving torque, and of the clutch of the vehicle, at improved weight parameters and overall dimensions, and at even distribution of the driving torques for the both directions of rotation. The construction of the inventive device includes two control hydraulic loops having a common gate mechanism, which are integrated in the common driving unit of the differential. The construction further includes separate control branches with electromagnetically actuating of the control devices and devices for smooth engagement and for reversing of the hydraulic flow, safety valves, electromagnetic control devices and throttles.

### FIELD OF THE INVENTION

The present invention relates to a control device for a hydraulic differential which is applicable in mechanical engineering, and particularly in automotive engineering, as well as everywhere where it is necessary an automatic distribution of the driving torque to a pair of functionally connected driven objects or to a single driven object.

### STATE OF THE ART

A hydraulic differential described in U.S. Pat. No. 6,505,722 and an active hydraulic differential as revealed in BG patent application No. 104550 are known, where the hydraulic control loops are embodied as volumetric hydraulic machine clutches and are integrated within a common driving part of the differential.

A common gate means acting as a distributor keeps the clutches blocked or de-blocks one of them depending on the value of the pressures formed in the loops. As revealed in BG patent application No. 104550, the electromagnetically actuated mechanical construction moves in the space around the rotating differential mechanism two control rings, thus acting on radial gates of control devices arranged in separate branches of the loops. The described active hydraulic differential is capable to react in the most effective way to the centrifugal forces during turns and to prevent slipping without using an additionally mounted registering, controlling and actuating arrangement co-working with the differential. The mechanism with the control rings makes the construction more complicated and loads functionally the space around the rotating hydraulic differential. One part of the gate which is mounted in the additional control branches of the loops, is within an area of high pressure, and the other part is disposed in the atmosphere. This requires usage of sealings, and there is a risk of leakage; the maximal working pressures are limited, thus the optimization of the weight parameters and overall dimensions of the differential is restricted. The possibilities of the above cited known constructions of the hydraulic differential mechanism for compensation of the wheel base differences between the rotation of the wheels and for eliminating of the clutch of the vehicle have not been realized. At reverse movement when the areas of high pressure and low pressure in the loops change, the distribution of the driving torques in the known constructions gets worse.

### SUMMARY OF THE INVENTION

An object of the present invention is to provide a control device for a hydraulic differential which eliminates the necessity of wheel base devices for distribution of the driving torque and of the clutch of the vehicle at improved weight parameters and overall dimensions, and at even distribution of the driving torques for both directions of rotation.

The technical problem is solved by providing a control device for a hydraulic differential containing two integrated within the common driving unit of the hydraulic differential control hydraulic loops having a distributor embodied as a common gate mechanism, where each of the loops includes two main collectors of toroidal configuration, and control branches with electromagnetically actuating of their control elements.

The gate of the main distributor is a rotating body in a form of a cylinder having an axial opening where at equal distances from the ends of the cylinder two identical discs thinned towards their periphery are formed. Thus the gate is symmetrical with respect to the plane crossing perpendicularly the middle of its longitudinal axis. The interior of the body of the main distributor has the same parameters of symmetry and is configured so that only in a neutral position of the gate at both sides of each disc separate chambers insulated from each other are formed. The chambers at each side of the gate are connected with areas of high and low pressure in separate hydraulic loops, so that the pressures of both loops have opposite directions to the discs of the gate along its longitudinal axis. The cross point of the longitudinal axis of the gate and its transverse plane of symmetry lies on this side of the rotating axis of the differential which crosses its common driving unit.

In each of the hydraulic loops in channels between the main collectors devices are mounted for smooth engagement of the differential clutches and for reversing the hydraulic flow. These devices include cylindrical gate with an axial channel, where at equal distances from its middle point across the cylindrical surface of the gate two parallel and radially oriented channels are formed. Opposite to each of these channels in the cylindrical surface of the gate two additional channels are radially formed, where each of these channels goes separately and parallel to the axial channel to the more distant end of the gate. The gate itself is mounted between two springs within a hollow cylindrical body in the middle of which opposite to each other two openings are radially formed. The hollow cylindrical body has caps each having an opening for connection with the main toroidal collectors of the loop, the inner sides of the caps being formed as seats of the gate, where in the base part of these seats connecting channels to the openings of the caps are formed. In this way the hydraulic loops of the clutches pass from the main toroidal collectors through the caps of the cylindrical body and through the opposite openings in its middle to a couple of additional toroidal collectors. The additional toroidal collectors are mounted within the driving unit externally and concentrically in relation to the couple of main collectors. The longitudinal axes of the devices are radially oriented within the driving unit of the differential and are arranged oppositely in relation to the axis of rotation of the differential.

Safety valves are mounted in separate branches of each of the loops, where the branches connect couples of the additional collectors. Each of the safety valves consists of a body including three successively connected hydraulic cylinders having a common axis of symmetry. Pistons are disposed within the two end cylinders of the body and partially in the space with working fluid of the middle cylinder which has the greatest diameter. Within the middle cylinder a spring is disposed which is in contact with the pistons, and the space of the cylinder is connected with a low pressure area of the loop by means of a channel coming from the middle of the cylinder. The outer ends of the cylinders are connected to the high pressure area of the hydraulic loop so that the channel to the cylinder with one of the pistons has a high hydraulic resistance. The head of the other piston in the second end cylinder is formed as a gate, which in its open position connects the areas of high pressure and low pressure of the loop through a separate channel. The diameter of the second piston acting also as a gate is smaller than the diameter of the first piston. The safety valves in the common driving unit of the differential have an opposite arrangement with regard to its axis of rotation toward which the axes of symmetry of the bodies have same angles.

Electromagnetically actuated devices are mounted in separate branches of each of the hydraulic loops. These devices are supplied through contact rings, which are fixed to the driving unit of the differential and are placed in a separate box attached to the casing of the differential. The armature of each of these devices has a cylindrical form with an axial opening and consists of a non-magnetic distributing part to which at least one magnetic part is rigidly connected. The devices are mounted within the driving unit oppositely in relation to the axis of rotation of the differential and have radially oriented longitudinal axes.

All additional toroidal collectors are connected to each other by means of hydraulic throttles. The high pressure collectors in each loop are connected to the low pressure collectors. There are such connections between the loops in the directions high—high and low—low pressure. The hydraulic throttles are mounted in the common driving unit symmetrically to its axis of rotation.

The vehicles with hydraulic differentials which are equipped with the invented control device avoid the necessity of a clutch and of wheel base devices for distribution of the driving torque, and have improved weight parameters and overall dimensions and even distribution of the driving torques for both directions of rotation.

### BRIEF DESCRIPTION OF THE DRAWINGS

One exemplary embodiment of a control device for a hydraulic differential is illustrated in the attached drawings, where:

FIG. 1 represents a schematic diagram of the hydraulic loops and the control devices of the hydraulic differential according to the invention.

FIG. 2 is a cross sectional view of the hydraulic differential representing the arrangement of the control devices in the common driving unit.

### EXEMPLARY EMBODIMENT OF THE INVENTION

According to the description and the attached drawings one exemplary embodiment of the control device for a hydraulic differential has the following construction: Two control hydraulic loops having a distributor embodied as a common gate mechanism are integrated within the casing of a hydraulic differential mechanism which is also a common driving unit of the differential. Each loop includes two main toroidal collectors and control branches with electromagnetically actuating of their control elements.

The gate 1 of the main distributor 2 is a rotating body in a form of a cylinder having an axial opening where at equal distances from the ends of the cylinder two identical discs thinned towards their periphery are formed. Thus the gate 1 is symmetrical with respect to the plane crossing the middle of its longitudinal axis.

The interior of the body of the main distributor 2 has the same parameters of symmetry and it is configured so that only in a neutral position of the gate 1 at both sides of each disc separate chambers insulated from each other are formed. The chambers at each side of the gate 1 are connected with areas of high and low pressure in separate hydraulic loops, so that the pressures of both loops have opposite directions to the discs of the gate 1 along to its longitudinal axis. The cross point of the longitudinal axis of the gate 1 and its transverse plane of symmetry lies on this side of the rotating axis of the differential which crosses its common driving unit.

For smooth engagement of the differential clutches and for reversing the hydraulic flow devices 3 are mounted in channels between the main collectors in each of the hydraulic loops. The devices 3 include cylindrical gate 4 with an axial channel where at equal distances from its middle point across the cylindrical surface of the gate 4 two parallel and radially oriented channels are formed. Opposite to each of these channels in the cylindrical surface of the gate 4 two additional channels are radially formed, where each of these channels goes separately and parallel to the axial channel to the more distant end of the gate 4. The gate 4 itself is mounted between two springs 5 within a hollow cylindrical body 6 in the middle of which opposed to each other two openings are radially formed. The hollow cylindrical body 6 has caps 7 each having an opening for connection with the main toroidal collectors of the loop, the inner sides of the caps being formed as seats of the gate 4, where in the base part of these seats connecting channels to the openings of the caps 7 are formed. In this way the hydraulic loops of the clutches pass from the main toroidal collectors through the caps 7 of the cylindrical body 6 and through the opposite openings in its middle to a couple of additional toroidal collectors 8. The additional toroidal collectors are mounted within the driving unit externally and concentrically in relation to the couple of main collectors. The longitudinal axes of the devices 3 are radially oriented within the driving unit of the differential and are disposed oppositely in relation to the axis of rotation of the differential.

Safety valves 9 are mounted in separate branches of each of the loops, where the branches connect couples of the additional collectors 8. Each of the safety valves 9 consists of a body 10 including three successively connected hydraulic cylinders having a common axis of symmetry. Pistons 11, 12 are disposed within the two end cylinders of the body 10 and partially in the space with working fluid of the middle cylinder which has the greatest diameter. Within the middle cylinder a spring 13 is disposed which is in contact with the pistons 11, 12, and the space of the cylinder is connected with a low pressure area of the loop by means of a channel coming from the middle of the cylinder. The outer ends of the cylinders are connected to the high pressure area of the hydraulic loop so that the channel to the cylinder with the piston 11 has a high hydraulic resistance. The head of the piston 12 in the second end cylinder having diameter smaller than the diameter of the piston 11 is formed as a gate, which in its open position connects the areas of high pressure and low pressure of the loop through a separate channel. The safety valves 9 in the common driving unit of the differential have an opposite arrangement with respect to its axis of rotation toward which the axes of symmetry of the bodies 10 have same angles. Electromagnetically actuated devices 14 are mounted in separate branches of each of the hydraulic loops. The devices 14 are supplied through contact rings 15, which are fixed to the driving unit of the differential and are placed in a separate box 16 attached to the casing of the differential. The armature 17 of each of the devices 14 has a cylindrical form with an axial opening and consists of a non-magnetic distributing part to which at least one magnetic part is rigidly connected. The devices 14 are mounted within the driving unit oppositely in relation to the axis of rotation of the differential and have radially oriented longitudinal axes.

All additional toroidal collectors 8 are connected to each other by means of hydraulic throttles 18. The high pressure collectors in each loop are connected to the low pressure collectors. There are such connections between the loops in the directions high—high and low—low pressure. The hydraulic throttles 18 are mounted in the common driving unit symmetrically to its axis of rotation.

### APPLICATION OF THE INVENTION

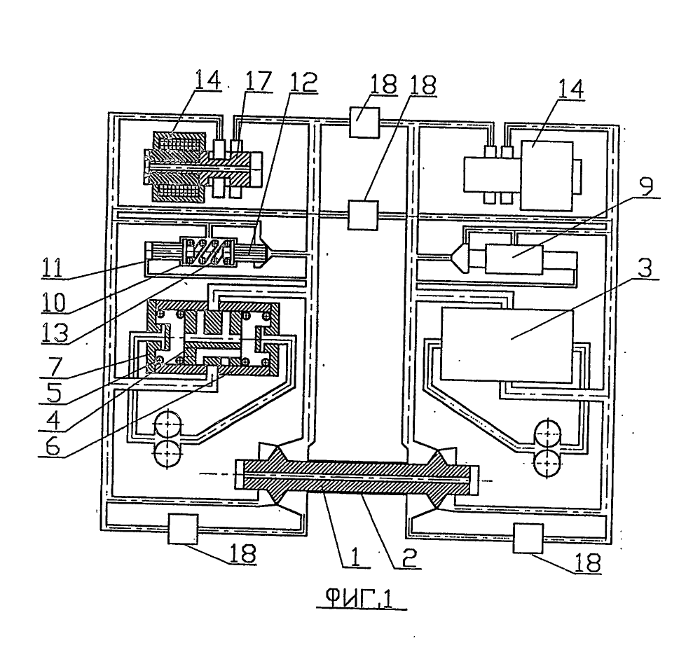

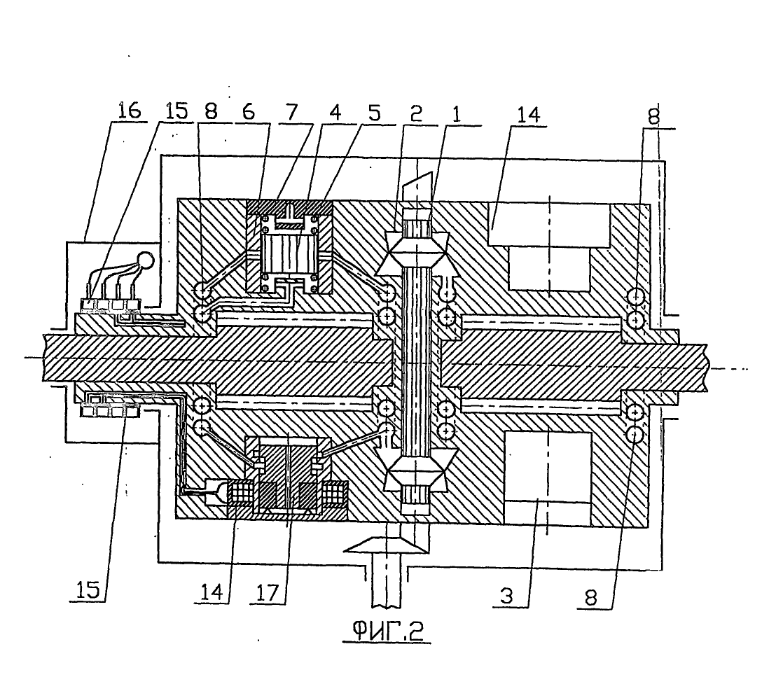

The presence of a pressure in the volume hydraulic motors schematically shown in FIG. 1 and working in clutch mode depends on two conditions: applying of a driving torque on the common driving unit of the differential and a presence of a resisting moment on the driven parts of the clutches. At low pressure, when the number of revolutions is low or the resistance on the driven parts is low, the fluid circulates through the following path: a high pressure area of the hydraulic clutch (for a given direction of rotating)—a main toroidal collector (FIG. 2)—a channel—an opening in one of the caps 7 of the device 3—connecting channels in the seat in the internal side of the cap and an axial channel of the gate; and then successively in the opposite direction, but through the other cap 7 and through the other main toroidal collector—in the low pressure area of the clutch. The direction of the circulated flow is opposite when the direction of rotation of the driving unit is opposite, i.e. at change of the direction of the movement of the vehicle. When increasing the flow pressure and the flow rate in each direction (by increasing the number of revolutions of the motor) the gate 4 overcomes the resistance of one of the springs 5 and moves along the pressure direction until pressing to the seat of the corresponding cap 7. The replacement of the gate until rest is accompanied by increasing the driving force on the driven parts, or on the driving wheels, respectively. In this way a smooth and automatic engagement of the wheels to the motor is achieved, and the necessity of the clutch of the vehicle is eliminated. At replacement of the gate 4 in one of the two end positions, the areas of high pressure and low pressure in the clutches, which change with the change of the direction of rotation, connect to this part of the corresponding control hydraulic loop where the direction of the fluid is constant and does not depend on the direction of rotation of the driving unit. This is a result of the rectifying action of the channels' configuration of the device 3 as specified in the description and in the drawings. This configuration determines the internal vertical lines as shown in FIG. 1 as high pressure areas. These are the internal additional toroidal collectors 8 in FIG. 2.

The gate 1 of the main distributor is in middle position only at equal pressure in both loops. In the present embodiment these are the pressures in both internal additional toroidal collectors 8. This is the only position of the gate 1 when no fluid can flow in the loops and corresponds to the cases of straight driving motion of the vehicle on a smooth and dry road. The gate balance is disrupted by roughness, at change of the direction of the vehicle and at loss of friction between the wheels and the road. Due to the practical incompressibility of the working fluid, the gate reaction is performed simultaneously with the external action. The change of the pressure in a given loop automatically changes the value of the driving force applied on the corresponding wheel. The displacement of the gate resulting from the pressure difference in the loops de-locks the clutches and allows the wheels to run different lengths of the road. The configurations of the gate 1 and of the distributor chambers ensure that flow passes at minimal displacements. This makes possible the correcting reaction of the differential to be performed during the action of the reason causing this correction. The gate 1 moves along the high pressure direction. For the configuration of the chambers in the distributor each displacement is accompanied by opening of a great flow section for circulation in the loop where the pressure is lower, and a minimal flow section in the loop with higher pressure. The provision of a turn of both driving wheels in relation to the driving unit contributes to the trouble-free overcoming of different hindrances by compensation of the differences in the passed lengths of the roads between the wheels of one driving shaft and between the wheels of two or more axles with a common propeller (cardan) shaft.

The safety valves 9 accomplish wheel base compensation of the differences between the passed roads in the only case when the main distributor can not perform such compensation. This is the case of simultaneous passing of both wheels of one driving axle over the same hindrances on a straight dry road. The device detects and reacts to each sharper increase in the pressure in the loop. It acts in the following way: the smooth increase in the pressure causes displacement of the piston 11 only, as it has diameter greater than that one of the head of the piston 12, and the force applied to it is greater. The rate of the displacement and the spring 13 deformation correspond to the value of the working pressure at that moment. The great resistance in the channel to the piston 11 delays the reaction of the piston at sudden short increases of the pressure in the loop. In these cases the piston 12 displaces and connects the high pressure area and the low pressure area and de-blocks the corresponding clutch. The spring 13 returns the piston 12 immediately after lowering of the pressure.

The electromagnetically actuated devices 14 operate at a power supply through the contact rings 15 and connect the high pressure areas and the low pressure areas in the loop. The connection between the drive wheel corresponding to that loop and the motor weakens. This causes redistributing of the driving torque on the wheels of the corresponding axle at an external command. The electromagnetically actuated devices 14 illustrated in the exemplary embodiment re-distribute the driving torque in advance for increasing the stability in driving in turns. The switching on of the devices 14 could be performed by turning of the steering wheel. The devices 14 can operate the differential in many ways. For example, at presence of a tensiometric sensor on the cardan shaft the need of safety valves 9 is eliminated because of the devices 14.

The axial channels in the armature 17 of the devices 14 and the channel in gate 1 of the main distributor allow the arrangement of the actuators of the control devices within chambers (spaces) which are entirely closed with tight barriers. Thus the usage of sealings which limit the maximal working pressures and complicate the motion of the gates and the risks of leakages are avoided.

Due to the hydraulic throttles 18 mounted between the high pressure area and low pressure area in one loop the parameters of both loops are equalized compensating for although the manufacture inaccuracies of the different elements.

The hydraulic throttles 18 mounted between the high pressure areas and low pressure areas of both loops accelerate the process of completing of each correcting reaction of the main distributor. The fluid flows through them only in case of different pressures in both loops. Further, by the throttles 18 specific adjustments depending on the concrete application of the differential could be performed.

The devices for smooth engagement and for reverse of the hydraulic flow 3, the safety valves 9, the electromagnetically actuated devices 14 in the inventive control device of the hydraulic differential can be used for automatic control of single hydro-volume clutches.

1-5. (canceled)

6. A control device for a hydraulic differential containing two hydraulic loops integrated within the common driving unit of the hydraulic differential control and having a distributor embodied as a common gate mechanism, where each of the loops includes two main collectors of toroidal configuration, and control branches with electromagnetically actuating of their control elements, wherein the gate of the main distributor is a rotating body in a form of a cylinder having an axial opening where at equal distances from the ends of the cylinder two identical discs thinned towards their periphery are formed, with the gate symmetrical with respect to a plane crossing perpendicularly the middle of its longitudinal axis, and with an interior of the body of the main distributor having the same parameters of symmetry and configured so that only in a neutral position of the gate at both sides of each disc are formed separate chambers insulated from each other, where the chambers at each side of the gate are connected with areas of high and low pressure in separate hydraulic loops, so that the pressures of both loops have opposite directions to the discs of the gate along its longitudinal axis, and the cross point of the longitudinal axis of the gate and its transverse plane of symmetry lies on the side of the rotating axis of the differential which crosses its common driving unit.

7. The control device for a hydraulic differential according to claim 6, wherein in each of the hydraulic loops are mounted in channels between the main collectors for smooth engagement of the differential clutches and for reversing the hydraulic flow, the devices including a cylindrical gate with an axial channel, where at equal distances from its middle point across the cylindrical surface of the gate two parallel and radially oriented channels are formed, and oppositely to each of these channels in the cylindrical surface of the gate two additional channels are radially formed, where each of these channels goes separately and parallel to the axial channel to the more distant end of the gate, which is mounted between two springs within a hollow cylindrical body in the middle of which opposite to each other two openings are radially formed, and the hollow cylindrical body has caps each having an opening for connection with the main toroidal collectors of the loop, the inner sides of the caps being formed as seats of the gate, where in the base part of these seats connecting channels to the openings of the caps are formed, thus the hydraulic loops of the clutches pass from the main toroidal collectors through the caps of the cylindrical body and through the opposite openings in its middle to a couple of additional toroidal collectors, which are mounted within the driving unit externally and concentrically in relation to the main collectors, where the longitudinal axes of the devices are radially oriented within the driving unit of the differential and are arranged oppositely in relation to the axis of rotation of the differential.

8. The control device for a hydraulic differential according to claim 6, wherein safety valves are mounted in separate branches of each of the loops, where the branches connect couples of the additional collectors, and each of the safety valves consists of a body including three successively connected hydraulic cylinders having a common axis of symmetry, where pistons are disposed within the two end cylinders of the body and partially in the space with working fluid of the middle cylinder having the greatest diameter, within which a spring is disposed and is in contact with the pistons, and the space of the cylinder is connected with a low pressure area of the loop by means of a channel coming from the middle of the cylinder, where the outer ends of the cylinders are connected to a high pressure area of the hydraulic loop so that the channel to the cylinder with the piston has a high hydraulic resistance, and the head of the piston in the second end cylinder having diameter smaller than the diameter of the piston is formed as a gate, which in its open position connects the areas of high pressure and low pressure of the loop through a separate channel, where the safety valves in the common driving unit of the differential have an opposite arrangement with regard to its axis of rotation toward which the axes of symmetry of the bodies have same angles.

9. The control device for a hydraulic differential according to claim 6, wherein electromagnetically actuated devices are mounted in separate branches of each of the hydraulic loops and are supplied through contact rings, which are fixed to the driving unit of the differential and are placed in a separate box attached to the casing of the differential, and an armature of each of the devices has a cylindrical form with an axial opening and consists of a non-magnetic distributing part to which at least one magnetic part is rigidly connected, where the devices within the driving unit are mounted oppositely in relation to the axis of rotation of the differential and have radially oriented longitudinal axes.

10. The control device for a hydraulic differential according to claim 6, wherein all additional toroidal collectors are connected to each other by means of hydraulic throttles, so that the high pressure collectors in each loop are connected to the low pressure collectors, and there are such connections between the loops in the directions high—high and low—low pressure, where the hydraulic throttles are mounted in the common driving unit symmetrically to its axis of rotation.
